(19) United States
(12) Patent Application Publication
(10) Pub. No.: US 2026/0320632 A1
(43) Pub. Date: Oct. 15, 2026

(54) SYSTEM AND METHOD FOR ENTITY RECOGNITION IN COMPUTERIZED DATA VERIFICATION USING MACHINE LEARNING MODELS

(71) Applicant: Actimize Ltd., Ra'anana (IL)

(72) Inventors: Sunny THOLAR, Pune (IN); Manish GULRANDHE, Pune (IN); Chetan PAULZAGADE, Pune (IN)

(73) Assignee: Actimize Ltd., Ra'anana (IL)

(21) Appl. No.: 19/175,464

(22) Filed: Apr. 10, 2025

(51) Int. Cl. G06Q 30/018

(52) U.S. Cl. CPC G06Q 30/0185

(57) ABSTRACT

A system and method for machine learning based entity resolution and fraud detection, including: extracting, by a first machine learning model, text components from a text input which identifies an entity, and training a second machine learning model using a plurality of features, including similarity scores calculated for extracted text components as well as for reference components. Some embodiments may compute predictive scores by the trained second machine learning model, indicating if a preliminary match or “hit” between the text input and a reference (e.g., from which reference component may be extracted) is a true match or hit-namely, whether the input and the reference refer to a single, real-world entity. Some embodiments may perform automated actions based on the computed scores, such as, e.g., blocking/delaying an exchange of data over a computer network when a score exceeds a predetermined threshold.

### FIELD OF THE INVENTION

The present invention relates generally to data verification, and more specifically to entity recognition and resolution in fraud detection.

### BACKGROUND OF THE INVENTION

In various realms of technology, the demand for robust entity recognition and data verification is paramount to ensure compliance and operational efficiency. At the core of this challenge is the technological need to accurately process and analyze vast amounts of data to distinguish between genuine and false matches between multiple, different database entries describing or associated with a single entity (e.g., a single real world entity or person).

For instance, technological challenge lie in developing systems that can effectively manage Know Your Customer (KYC) compliance by continuously monitoring business relationships. The high rate of false positives in sanction screening (e.g., a case where a user or customer is falsely identified to match a name in a governmental sanction database), often exceeding 95%, highlights the inefficiencies of some current technological solutions, which result in significant burdens due to the need for manual intervention (being itself prone to errors).

In healthcare, a technological imperative is to ensure accurate patient identification through advanced data processing systems to prevent medical errors. In telecommunications, the focus is on developing secure systems for verifying customer identities to prevent fraud. E-commerce platforms rely on technology to enhance user experience and prevent fraudulent transactions through precise customer identification. Various additional use cases of entity verification and resolution may be realized.

Existing technological solutions for entity or data verification and resolution often rely on basic matching techniques using a limited number of features. These methods frequently overlook critical elements such as name affixes, stems, and qualifications, which may be essential for accurate entity recognition. Consequently, current technologies often produce many false positive matches.

There is a pressing need for innovative technological approaches that integrate advanced machine learning models and data processing techniques to improve the accuracy and efficiency of entity recognition systems.

### SUMMARY

Some embodiments of the invention may provide a system and method for machine learning based entity resolution and fraud detection.

Some embodiments may extract, by a first machine learning model or large language model (LLM), text components from a text input which identifies an entity, and train a second machine learning model (e.g., a traditional machine learning model separate and distinct from the first model or LLM used for extracting text components) using a plurality of features-including, e.g., similarity scores calculated for extracted text components and for respective reference components.

Some embodiments may compute predictive scores by the trained second machine learning model, indicating if a preliminary match or “hit” between the text input and a reference (e.g., a watchlist entry, from which reference component may be extracted) is a true match or hit-namely, whether the input and the reference refer to a single, real-world entity.

Some embodiments may perform automated actions based on the computed scores, such as, e.g., blocking/delaying an exchange of data or computerized transaction taking place over a computer network when a score exceeds a predetermined threshold.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 shows an example system and workflow for entity recognition according to some embodiments of the invention;

FIG. 3 illustrates an example process for extracting text components using a large language model (LLM) according to some embodiments of the invention;

FIG. 4 shows an example process for generating similarity score based features according to some embodiments of the invention;

FIG. 5 shows an example data processing and model training process according to some embodiments of the invention;

FIG. 6 illustrates example feature engineering and selection processes according to some embodiments of the invention;

FIG. 7 shows an example implementation of similarity based features in a fraud detection system according to some embodiments of the invention;

FIG. 8 shows an example alert generation process according to some embodiments of the invention; and

FIG. 9 shows an example process for machine learning based fraud detection according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Embodiments of the invention may provide systems and methods for robust entity and/or name recognition in data verification using machine learning (ML) models. This may improve text processing and fraud detection technology by minimizing false positives or false hits (e.g., falsely determining that two unrelated entities or names A and B refer to a single entity X). Some embodiments may use advanced computational tools and techniques such as for example large language models (LLMs) and text embedding models, to provide a robust computerized approach for entity recognition across various technological sectors (e.g., in healthcare, financial institutions, and more). Some embodiments may provide an entity verification approach using a plurality of machine learning models, where, for example, an LLM may be used for extracting text components from database entries or inputs, and extracted text components may be used to train a machine learning model (that may be separate and distinct from the LLM used to extract text components) for detecting a match or mismatch between entities.

Entity or recognition or matching as used herein may refer to identifying and verifying individuals or entities based on their names/identifiers, which may be for example names of individuals (see nonlimiting examples herein). According to some embodiments, a “match” or “hit” may occur when a name in a dataset corresponds to a name on a reference list, such as a watchlist, where a name or identifier of an entity may be flagged for further investigation due to its apparent presence on such lists. False positives may arise when the system incorrectly identifies a match or hit—e.g., when a name provided to the system (e.g., of a user performing a financial transaction) is identified as similar, or sufficiently similar, to a watchlist entry (e.g., of a sanctioned individual who is not permitted to take part in financial transactions), leading to unnecessary investigations. Some embodiments may be used to improve entity or name recognition technologies and to minimize false positives.

A “transaction” as used herein may refer to the exchange or transfer of computerized data between computer systems, for example, over a computerized data network (such as for example the internet). While some nonlimiting examples provided herein with regard to some embodiments of the invention may relate to exchanges of data relating to potential financial fraud or risks—other embodiments may relate to exchanges of computerized data unrelated to finance or to human activity: for example, some embodiments of the invention may be used for entity verification in contexts relating to communications between computer servers (for example, where a single entity or server is associated with multiple different names or identifiers, which may be correlated or identified to potentially refer to a single server as opposed to multiple different servers). Examples provided herein with reference to financial transactions and related entities (e.g., a bank, customer, and the like) should be considered nonlimiting, and additional or alternative use cases may be realized.

A “hit” as used herein may refer to a match or potential match identified during the process of screening names or entities against a list of names, such as for example a watchlist (for example, a hit may occur when a name “John Mill” is identified to match an entry of “J. S. Mill” on a watchlist W, where W={N. Machiavelli, R. Descartes, D. Hume, J. S. Mill, . . . }). This process may be used, for instance, in financial institutions and other sectors to ensure compliance with regulations and to prevent fraud—for example by comparing a name (e.g., of an entity such as for example a customer participating in a computerized transaction across a computer network) with reference names (such as, e.g., names found on a governmental list of sanctioned individuals which may be prohibited in taking part in transactions). Other example of a “hit” may apply, e.g., to the healthcare sector. For example, a hospital's patient management system that screens patient names against a list of individuals who have been flagged for specific health conditions that require special attention or isolation due to contagious diseases. When a new patient is registered, their name may be checked against this list. If the system identifies a match, or “hit,” it may indicate that the patient may have a condition that requires immediate medical protocols to be followed, such as isolation or specialized treatment. This process may help ensure patient safety and public health by quickly identifying individuals who need special care. Additional or alternative nonlimiting use cases may relate to different embodiments of the invention.

According to some embodiments, an initial match or a “hit” may be detected by a name matching engine intelligently parsing input names using computational natural language processing (NLP) algorithms for “fuzzy matching” (which may refer to “loose” matching or to matching where not all words/tokens in the entities being matched are identical). The matching engine may parse names and screen names against watch lists, for example taking into account possible misspellings or alternative spellings of the names being matched. Some example algorithms that may be used in some embodiments of the invention as part of fuzzy name or identifier matching (and as part of identifying “hits” that may then be validated or examined using entity resolution techniques) include the Levenshtein Distance, Damerau-Levenshtein, Jaro-Winkler, Soundex, Metaphone, and Smith-Waterman algorithms. Entities matched as part of an initial matches or hits may then be input into entity resolution procedures according to some embodiments of the invention, e.g., to determine whether an initial match or hit it a true hit (namely, whether the initially matched entities in fact refer to a single, real world entity or person), or whether the match is not a false positive. Additional or alternative techniques may be used for identifying or detecting hits according to different embodiments.

Some approaches and procedures for entity matching may consider only explicit name matching. However, important features such as name affixes, name stems, and name qualifications may be omitted form the analysis-a factor that may leads to a high false positive rate (e.g., to falsely matching entities that are in fact unrelated).

Some embodiments may identify and extract text components, e.g., using an LLM, from a text input. For example, for a text input including an entity name or identifier, such as for example the full name of an individual, e.g., “John Stuart Mill”. Example text components or segments that may be identified and extracted from the text input may include, e.g.:
Title (such as for example prefixes, “Mr.”, “Dr.”, and the like).
Qualification (suffixes such as, e.g., “Ph.D.”, “MBA”).
Culture/country (country names, cultural or regional information such as, e.g., “United Kingdom”).
Gender: may be inferred based on the name (e.g., “Male”).
   Additional or alternative components may be identified/extracted and used by different embodiments.

Some embodiments may, for example, convert each identified or extracted name component into one or more vector or numerical embeddings, for example using a Large Language Model (LLM) or an embedding model (which may be, for example, a machine learning model separate and distinct from the LLM used for extracting name components). Generated embeddings may be used to capture semantic and syntactic information of each extracted segment or component. Some embodiments may calculate similarity scores or metrics (such as for example a cosine similarity score), between embeddings to identify patterns and relationships among name components or segments; extract or compute a plurality of features based on the computer or generated embeddings and similarity scores or metrics; append or combine extracted features, with other data transfer or transaction features, to form a new feature set- or a feature set including similarity based features for name components or segments (also referred to as “enhanced features” or similarity features); and train a machine learning model (such as for example a predictive scoring model, which may be a “second” model separate from the LLM used to extract name components) using the new feature set—for example to predict the probability of a specific outcome (e.g., a probability value for a hit being a true hit and not a false positive or a false match or two entities, having for example a form of P(HIT)=0.65=65%). Additional or alternative operations may be used in different embodiments.

A plurality of machine learning (ML) models may be used as part of entity or name recognition processes according to some embodiments of the invention. For example, in some embodiments, a first ML model may be an LLM extracting text components from a text input; a second ML model may be a predictive model generating or outputting a probability that a hit is a true hit and not a false positive; and a third ML model may be an embedding model generating embeddings for text components or segments. Additional or alternative implementations, including a different number of models performing different tasks, may be used in different embodiments.

Some example embodiments of the invention may be integrated with existing systems or platforms such as for example the Actimize Watch and/or the WLX fraud detection platforms by Actimize Ltd. Different embodiments, however, may use or be integrated into different systems or platforms.

Some embodiments of the invention may improve computerized data management technology by making robust predictions based on analyzing and processing large volumes of data (such as for example computerized databases or datasets including thousands or millions of entries)—a task which is practically impossible for a human to carry out. Some embodiments may identify patterns and relationships among data elements, significantly reducing false positives (such as for example false matches between different, unrelated entities) and improving predictive accuracy. An integration of LLMs with traditional machine learning algorithms according to some embodiments may offer a scalable and effective solution for robust entity recognition across various technology sectors.

To identify a larger number of genuine entity match hits (or “true hits”, as opposed to false positive hits or hits where two or more names A and B are falsely identified to refer to a single entity or user X, where in fact they should refer to two separate and distinct entities X and Y), some embodiments may combine LLM technology with traditional machine learning models, techniques, and algorithms. In some embodiments, information or textual components may be extracted from names using an LLM or LLMs, and then match scores may be generated for each extracted piece of information (or for each extracted text component) by calculating similarity scores or values using numerical embeddings or vector embeddings representing extracted components. Similarity scores or metric values may be subsequently used as features and may be integrated or used with additional features (such as for example various predictive features not based on name components or similarity scores) to train a machine learning model for predicting true hit probabilities (e.g., the second model). Some embodiments may significantly enhance the overall effectiveness of hit detection, leading to increased performance in entity verification or name matching (as may be reflected in performance metrics such as, e.g., “recall”, which may refer to a measure of a model's ability to identify all relevant instances in a dataset).

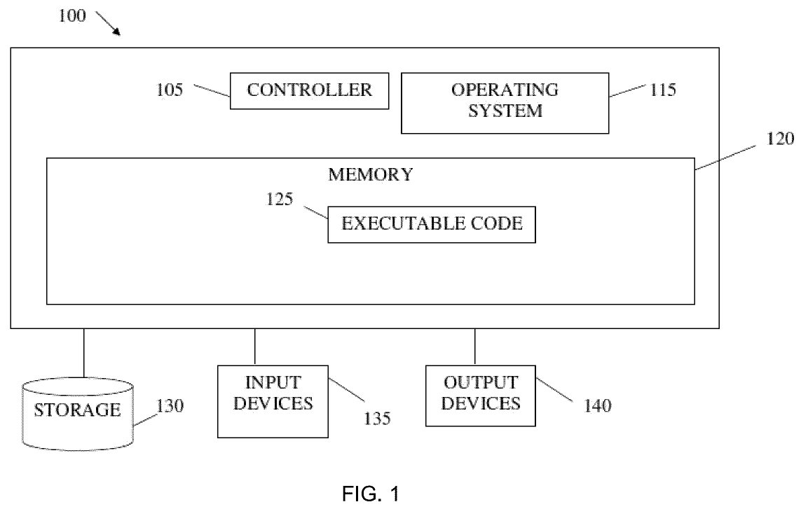

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or output data, etc.

Executable code 125 may be any application, program, process, task, or script. Executable code 125 may be executed by controller 105 possibly under control of operating system 115. For example, executable code 125 may be or execute one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods and procedures disclosed herein.

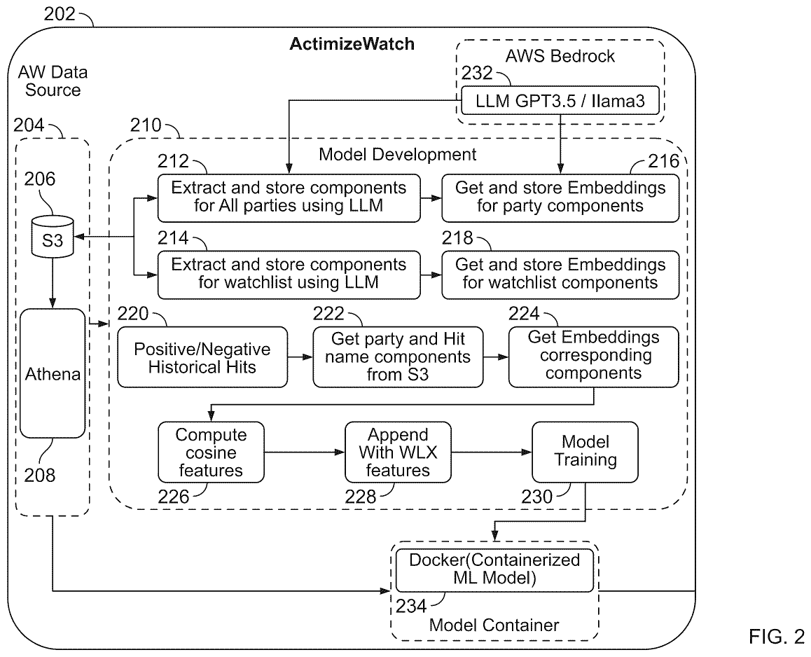

FIG. 2 shows an example system and workflow for entity recognition according to some embodiments of the invention.

A fraud detection system or platform, such as for example the ActimizeWatch (AW) 202 platform by Actimize Ltd., may be used for coordinating data processing and model development activities according to some embodiments of the invention (although different embodiments may use or may be integrated into different systems or platforms). In some embodiments, Actimize Watch 202 may operate as a hub that connects various data sources and computational resources to support the extraction, transformation, and analysis of data for entity recognition and fraud detection. Actimize Watch 202 may interact with AW Data Source 204, which may include, for example, cloud storage solutions such as the Amazon Web Services (AWS) S3 206 and Athena 208 solutions, to access and manage the data needed for, e.g., model training and evaluation.

AW Data Source 204 may include the AWS S3 206 and Athena 208 storage solutions, which may be utilized for data storage and querying operations. S3 206 may serve as a scalable and secure storage solution where raw data, such as party information and watchlist details, may be stored. Athena 208 may allow for efficient data retrieval and analysis using standard query language (SQL) queries. It may allow directly querying of the data stored in S3 206 using standard SQL language. This may eliminate the need to set up and manage a separate database, making data exploration and analysis more efficient.

Some embodiments may include a first machine learning model, which may be, e.g., LLM 232, and which may be used to extract text components from a text input—as well as a second machine learning model 234 that may be used for computing or outputting predictive scores or true hit probabilities.

In some embodiments vector embeddings may be computed using an embedding model (which may be referred to as a “third machine learning model”—which may be, for example, a machine learning model separate and distinct from the model used to extract name components and/or from the predictive model used to compute or calculate a true hit probability or predictive score). Tables 1-2 show nonlimiting example operations included in model development 210 according to some embodiments of the invention:

TABLE 1

| | Block | Operation | Algorithms/Tools | Example Trigger/Interface/Flow |
|---|---|---|---|---|
| 1 | Extract and Store | 1. If names | LLM Call: Use | Batch processing may be |
| | Components for All | valid → Send | application | used and run, e.g., once for |
| | parties Using LLM | API request | programming | parties in beginning. |
| | | to LLM. | interfaces (APIs) such | Batch may run, for |
| | | Else → Log | as for example | instance, when a new |
| | | and request | OpenAI API (e.g., of | party or entity is registered |
| | | user | GPT4o) or AWS | into a system (e.g., |
| | | correction. | Bedrock API, and the | onboarded in a bank and |
| | | 2. Receive | like, e.g., with | added to a database of |
| | | JSON | prompts for name | customers) |
| | | response | parsing. | |
| | | 3. Parse into | | |
| | | components | | |
| | | (e.g., affix, | | |
| | | title, root) | | |
| | | 4. Save | | |
| | | components | | |
| | | in storage | | |
| | | (S3/DB) | | |
| 2 | Get and Store | 1. For each | Embeddings API: may | |
| | Embeddings for Party | name | use, e.g., OpenAI | |
| | component | component | Embedding API (e.g., | |
| | | generate | text-embedding-ada- | |
| | | embeddings | 002) | |
| | | using LLM | | |
| | | embedding | | |
| | | API. | | |
| | | 2. Store | | |
| | | embeddings: | | |
| | | If storage | | |
| | | successful → | | |
| | | Confirm | | |
| | | operation. | | |
| | | Else → Retry | | |
| | | or log error. | | |
| 3 | Extract and Store | 1. If names | LLM Call: may use | Batch processing may be |
| | Components for | valid → Send | APIs such as, e.g., | used, e.g., once for |
| | Watchlist Using LLM | API request | OpenAI API or AWS | watchlist names in |
| | | to LLM. | Bedrock with prompts | beginning. Batch may run, |
| | | Else → Log | for name parsing. | for instance, when a new |
| | | and reqest | | name added in watchlist |
| | | user | | |
| | | correction. | | |
| | | 2. Receive | | |
| | | JSON | | |
| | | response | | |
| | | 3. Parse into | | |
| | | components | | |
| | | (e.g., affix, | | |
| | | title, root) | | |
| | | 4. Save | | |
| | | components | | |
| | | in storage | | |
| | | (S3/DB) | | |
| 4 | Get and Store | 1. For each | Embeddings API: may | |
| | Embeddings for | name | use, e.g., OpenAI | |
| | Watchlist component | component | Embedding API (e.g., | |
| | | generate | text-embedding-ada- | |
| | | embeddings | 002) | |
| | | using LLM | | |
| | | embedding API. | | |
| | | 2. Store | | |
| | | embeddings: | | |
| | | If storage | | |
| | | successful → | | |
| | | Confirm | | |
| | | operation. | | |
| | | Else → Retry | | |
| | | or log error. | | |
| 5 | Positive/Negative | 1. Retrieve | Data Sampling and | May be run, e.g., using |
| | Historical Hits | historical hit | validation split: | Python Jupyter notebook |
| | | data: | Stratified sampling | |
| | | If | may be used to | |
| | | positive/ | balance classes (for | |
| | | negative data | example using the | |
| | | available → | sklearn Python | |
| | | Load into | library). | |
| | | system. | | |
| | | 2. Split into | | |
| | | training and | | |
| | | validation | | |
| | | datasets. | | |
| 6 | Compute Cosine | 1. Pair | Calculate Cosine | May be performed, e.g., |
| | Features | embeddings | Similarity: may use | using a Python Jupyter |
| | | (party vs. | libraries such as, e.g., | notebook |
| | | watchlist | scipy.spatial.distance.cosine | |
| | | components). | | |
| | | 2. Calculate | | |
| | | cosine | | |
| | | similarity: | | |
| | | If similarity | | |
| | | above | | |
| | | threshold → | | |
| | | Mark as | | |
| | | potential | | |
| | | match. | | |
| | | Else → | | |
| | | Discard. | | |
| 7 | Append with WLX | 1. Fetch | python custom | May be performed, e.g., |
| | Features | WLX | function using library | using a Python Jupyter |
| | | features for | pandas | notebook |
| | | the hit. | | |
| | | If features | | |
| | | available → | | |
| | | Append. | | |
| | | Else → Log | | |
| | | warning. | | |
| | | 2. Combine | | |
| | | cosine | | |
| | | features with | | |
| | | WLX | | |
| | | features. | | |
| 8 | Model Training | 1. Train | Gradient Boosting: | May be performed, e.g., |
| | | model: | XGBoost | using a Python Jupyter |
| | | Use training | | notebook |
| | | data and, e.g., | | |
| | | XG-Boost | | |
| | | algorithm. | | |
| | | If training | | |
| | | converges → | | |
| | | Save model. | | |
| | | Else → | | |
| | | Adjust | | |
| | | hyperparameters | | |
| | | and retry. | | |
| | | 2. Validate | | |
| | | model: | | |
| | | If accuracy | | |
| | | acceptable → | | |
| | | Finalize | | |
| | | model. | | |
| | | Else → Retry | | |
| | | with different | | |
| | | parameters. | | |

Model development 210: generation of LLM-based enhanced features:

TABLE 2
Extract and Store Components Using LLM:
For All Parties 212: Name components of all parties may be extracted using an
LLM 232 (such as, e.g., GPT-3.5 or Llama 3, may also be referred to as a “first
machine learning model”). Extracted components may be stored for further
processing.
For Watchlist 214: Watchlist name components may similarly be extracted and
stored.
Get and Store Embeddings:
For Party Components 216: Embeddings may be generated for the extracted party
components (for example using LLM 232 or a different/separate machine learning
model) and stored for similarity computations.
For Watchlist Components 218: Embeddings may be generated for the watchlist
components in the same manner.
Positive/Negative Historical Hits 220: Historical hit data, marked as positive or negative,
may be retrieved for training the model.
Get Party and Hit Name Components from S3 222: Party and hit name components may
be retrieved from the S3 bucket for comparison and analysis.
Get Embeddings for Corresponding Components 224: Embeddings for the retrieved
components are fetched for similarity calculations.
Compute Cosine Features 226: Using the embeddings, a similarity metric or score such as
for example a cosine similarity may be computed between party and watchlist components
or name segments to derive similarity features.
Append with Additional (WLX) Features 228: Additional features, such as, e.g., those
provided by or derived from an external or additional data processing system, such as for
example the WLX system or platform by Actimize Ltd., may be added to the computed
similarity features, resulting in a richer feature set.
Model Training 230: A predictive machine learning model 234 (such as for example a
model separate and distinct from the LLM used for extracting text components, which may
also be referred to as the “second machine learning model”) may be trained using, for
example the cosine similarity features, WLX features, Historical hit labels
(positive/negative), and more.

In some embodiments, the trained ML model may be containerized using a containerization platform such as, for example, using the Docker platform for ease of deployment and scalability. This containerized model can be integrated into production systems or environments as a model container. Additional or alternative operations or components may be used in different embodiments of the invention.

In some embodiments, data or information items including, for example, entity or customer information and/or watch list, Global Name Recognition (GNR) data, and the like, may be stored in a database such as, e.g., Actimize Watch S3. Data items stored and used by some embodiments may encompass a diverse range of data types and formats, such as for example static customer data, demographic details and contact information, and mode. Some example data formats that may be used in some embodiments may include tabular and/or standard query language (SQL) data, JavaScript object notation (JSON) files, and the like. Different formats may be used in different embodiments.

Some nonlimiting example data items that may be used in some embodiments of the invention are described in Table 3:

TABLE 3
WLX Data or Watchlist Data may include, for example:
Sanctions Lists: These lists may include names of individuals and entities
sanctioned, for example, by governments or international organizations (due to
involvement in activities like terrorism, money laundering, human rights violations,
and the like).
Example: A list maintained by the U.S. Department of the Treasury's Office
of Foreign Assets Control (OFAC) containing names of individuals and
entities associated with terrorism or other illicit activities.
PEP (Politically Exposed Persons) Lists: These lists may include names of
individuals who hold or have held prominent public positions. PEPs may be
considered as a sector prone to financial crimes, due to their potential vulnerability
to bribery and corruption.
Example: A list maintained by a financial institution containing names of
individuals who have held high-level government positions in various
countries.
Adverse Media: This type of data may include news articles, court documents,
and other publicly available information that may indicate potential risk.
Example: A news article reporting on an individual's involvement in a
financial scandal.

In some embodiments, HIT, reference names and/or reference components may be specified in a watchlist of entities—which may be or may include, e.g., a list of identifiers/names or watchlist having the example format illustrated in Table 4:

TABLE 4

| | | | Date of | | Risk | | |
|---|---|---|---|---|---|---|---|
| No. | Name | Aliases | Birth | Nationality | Level | Category | Notes |
| 001 | John Doe | J D, | 1985 | USA | High | Sanctions List | Listed by OFAC; |
| | | Johnny D | Jul. 12 | | | | Fraudulent |
| | | | | | | | activities |
| 002 | María | Maria G., | 1990 | Mexico | Medium | Criminal | Suspected in |
| | Gonzalez | M G | Mar. 25 | | | Watchlist | money laundering |
| 003 | Ahmed Al- | A. Al- | 1978 | UAE | High | Terrorism | Connected to |
| | Farsi | Farsi | Nov. 02 | | | Watchlist | terrorist |
| | | | | | | | organization |
| 004 | Wei Zhang | Zhang | 1982 | China | Low | PEP (Politically | Senior government |
| | | Wei, W. Z. | Sep. 15 | | | Exposed Person) | official |
| 005 | Ivan | I. Petrov | 1975 | Russia | High | Sanctions List | Subject to EU and |
| | Petrov | | May 20 | | | | UN sanctions |
| 006 | Fatima | F. Baloch | 1988 | Pakistan | Medium | Criminal | Involved in |
| | Baloch | | Dec. 30 | | | Watchlist | organized crime |
| | | | | | | | activities |
| 007 | James | Jim | 1993 | UK | Low | Watchlist | Under investigation |
| | Smith | Smith, J. | Jun. 10 | | | | for cyber fraud |
| | | Smith | | | | | |

Additional or alternative formats may be used in different embodiments.

Some embodiments of the invention may use labeled training data—such as for example names or identifiers labeled as “issue” or “non-issue” where ‘issue’ may indicate the name matched a name on a watchlist as a true hit, and ‘non-issue’ which may indicate the name matched a name on a watchlist but turned out to be a false hit, or a false positive match (for example, where an entity name and a watchlist name in fact refer to different, real world people-despite a preliminary matching between the two names). Machine learning models according to some embodiments may use such labeled in training, e.g., to learn which names correspond to true hits and which to false hits. Additional or alternative training data and/or procedures may be used in different embodiments.

Some embodiments may receive, extract, or use GNR (Global Name Recognition) data, which may correlate or link a plurality of different identifiers or names with a single key or identifier, which may indicate that the plurality of different identifiers refer to a single entity or used (associated with the linked key or identifier).

For example, a customer database may include the following entries:
John Smith
J. Smith
Juan Smith
Giovanni Smith
   Without GNR data, these records may be treated or considered as referring to as separate entities (namely, John Smith and J. Smith are not determined to refer to a single, real life person). GNR data may refer to data items or elements including links between different records, such as for example a data item indicating or determining that John Smith and J. Smith refer to the same person (for example linking a single, common identifier for two database records, each including the name John Smith, and J. Smith, respectively). In some embodiments, GNR data may be determined using appropriate tools and based on various factors, such as for example:
Soundex, which may refer to phonetic algorithm that encodes names based on their pronunciation or on how they sound, helping to match names with similar pronunciations (such as, e.g., Daniel and Danil).
Metaphone, which may refer to a phonetic algorithm that may improve upon Soundex by handling more complex sound patterns.
Cultural variations: some embodiments may recognize that “John” and “Juan” are equivalent names in different languages. Some embodiments may identify cultural variations, for example by comparing embeddings using similarity scores (e.g., according to a cosine similarity formula) to determine proximity within a vector space, indicating how closely related the names are. Short distances or high similarity scores may indicate that two names are cultural variations of one another. Additionally or alternatively, fuzzy matching algorithms may be used to identify cultural variations. Alternative techniques may be used in different embodiments.

In some embodiments, GNR data may have the example format illustrated in Table 5:

TABLE 5

| | | Local | | | | | |
|---|---|---|---|---|---|---|---|
| | Primary | Variants/ | | Phonetic | | Common | |
| No. | Name | Transliteration | Script | Variants | Country/Region | Misspellings | Notes |
| 001 | [symbol] | [symbol] | Arabic | Muhammed | Egypt, | Mohamad | Common |
| | (Muhammad | (Arabic), | | Ali, | Pakistan, | Aly, | Arabic |
| | Ali) | [symbol] | | Mohamad | UAE | Mohammad | name; can |
| | | (Urdu) | | Ali | | Ali | refer to |
| | | | | | | | multiple |
| | | | | | | | entities |
| 002 | [symbol] | [symbol] | Chinese | Chang | China, | Zang Wey, | One of the |
| | (Zhang | (Traditional | | Wei, Zang | Taiwan | Jang Wei | most |
| | Wei) | Chinese) | | Wei | | | common |
| | | | | | | | Chinese |
| | | | | | | | names |
| 003 | [symbol] | [symbol] | Cyrillic | Evan | Russia, | Ivan | Common |
| | [symbol] | [symbol] | | Ivanoff, | Ukraine, | Ivannov, | Eastern |
| | (Ivan | (Ukrainian) | | Iwan | Bulgaria | Iwan | European |
| | Ivanov) | | | Iwanov | | Ivanof | name |
| 004 | María | Maria | Latin | Mariya | Spain, | Maria | Common |
| | Gonzalez | Gon [symbol] alves | | Gonzalez, | Mexico, | Gonsalez, | Hispanic |
| | | (Portuguese) | | Mariah | Brazil | Marya | name |
| | | | | Gonzales | | Gonzalez | |
| 005 | [symbol] | [symbol] | Arabic | Ahmet | Saudi Arabia, | Ahmed Al | Variations |
| | (Ahmed | (Urdu) | | Hassani, | Iraq | Hassni, | in |
| | Al- | | | Ahmad | | Ahmad | transliteration |
| | Hasani) | | | Alhassani | | Hasani | |
| 006 | Jean | Jean | Latin | Zhawn | France, | Jhon | French |
| | Dupont | DuPont, | | Dyoo-pon | Belgium | Dupont, | surname; |
| | | Jean | | | | Jean | may |
| | | Du Pont | | | | Dupon | indicate |
| | | | | | | | different |
| | | | | | | | people |
| 007 | [symbol] | [symbol] | Cyrillic | Aleksandr | Ukraine, | Alexander | Spelling |
| | [symbol] | [symbol] | | Petrov, | Russia | Petrov, | differs by |
| | (Oleksandr | (Russian) | | Olek | | Olexandr | region |
| | Petrov) | | | Petrov | | Petrov | |
| 008 | [symbol] | [symbol] | Greek | Kiriakos | Greece, | Kyriacos | Common |
| | [symbol] | [symbol] | | Papadopulos | Cyprus | Papadopoulosreeks, | Greek |
| | o [symbol] | o [symbol] | | | | Kyrikos | surname |
| | (Kyriakos | (Greek) | | | | Papadopolos | |
| | Papadopoulos) | | | | | | |

Additional or alternative formats may be used in different embodiments.

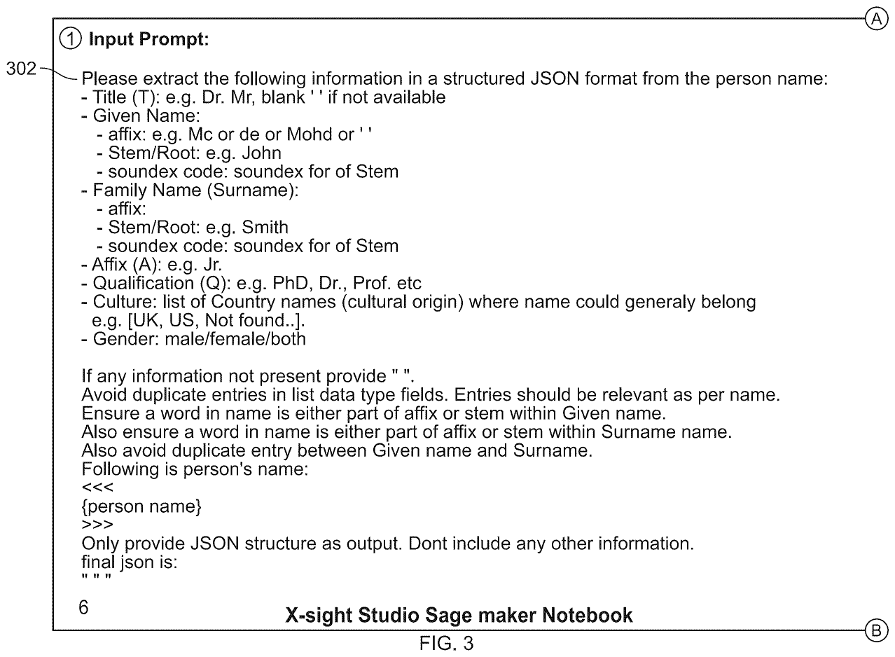

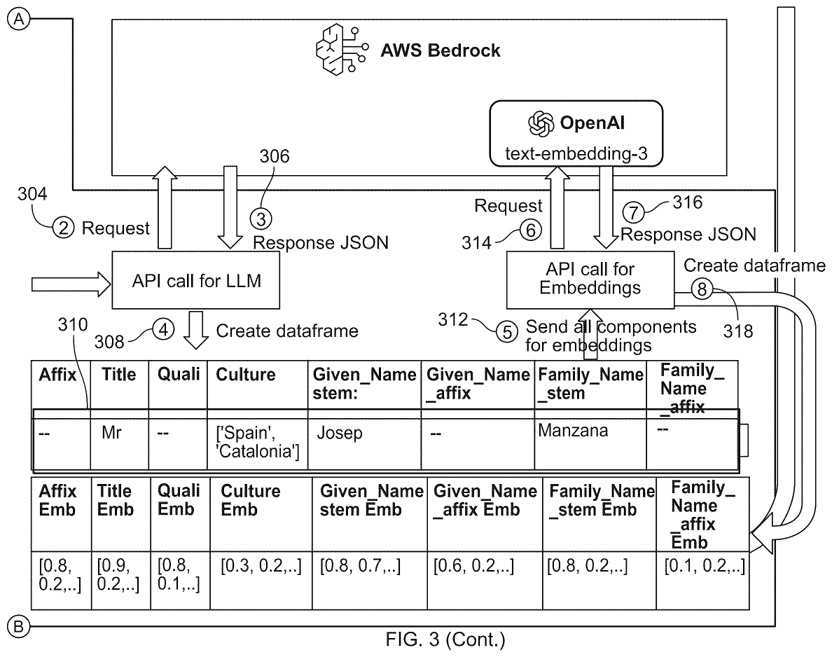

FIG. 3 illustrates an example process for extracting text components using a large language model (LLM) according to some embodiments of the invention.

Some embodiments may include extracting, by a first machine learning model, one or more text components from a text input, the text input identifying an entity. In some embodiments vector embeddings may be computed using an embedding model (which may be referred to as a “third machine learning model”—which may be, for example, a machine learning model separate and distinct from the model used to extract name components and/or from the predictive model used to compute or calculate a true hit probability or predictive score).

An example process for extracting identifying text components, such as, e.g., name components, from a text input using an LLM (or a “first machine learning model”) is provided in Table 6.

TABLE 6
Operation 1: Input Prompt 302 Creation
A user or system administrator may prepare an example input prompt 302
specifying information to be extracted from a given input text (e.g., an input
denoted person_name). Requested information or components may include, e.g.:
Title (e.g., Mr., Dr.).
Given Name (with affix, stem/root, and Soundex code).
Family Name/Surname (with affix, stem/root, and Soundex code).
Affix (e.g., Jr.), Qualification (e.g., PhD, Dr., etc.), Culture (a list of country names
for possible countries related to the name), Gender (male/female/other), and the
like.
Example prompt 302 may also determine or specify additional settings or
preferences, e.g., that missing information may be represented with “” and that
duplicates are to be avoided.
Operation 2: Send Request 304 to LLM API
Example text input and input prompt 302 may be sent to the LLM (via, e.g., an
AWS Bedrock API) to process the input text or person_name (e.g., text
input = “Customer no. 09823423, Dr. John S. Smith Jr., London, UK, male”).
Operation 3: Receive Response 306 from LLM
The LLM may return a structured JSON response including the extracted text
components 310 identifying an entity (e.g., components “Dr.”, “John S.”, “Smith”,
“Jr.”, “UK”, “male” . . . and more, may be extracted from the text input).
Operation 4: Dataframe Creation 308
The JSON response may be parsed into a dataframe, organizing extracted
components 310 into columns such as Title, Qualification, Culture, Given Name
stem, Given Name affix, etc.
Operation 5: Sending Components for Embeddings 312
The components from the data frame may be sent to an API for generating vector
embeddings for each component.
Operation 6: Request to Embedding API 314
A request may be made to an embeddings API for each name component.
Operation 7: Response from Embedding API 316
The embeddings API may return a response including vector embeddings for each
name component (which may be labeled, e.g., Affix_Emb, Title_Emb, etc.).
Operation 8: Embedding Integration 318
The generated embeddings may be integrated into the relevant dataframe, creating
a new row for each component's corresponding embedding.

Table 7 shows an example prompt for extracting identifying text components by an LLM:

TABLE 7
Extract the following information in a structured JSON format from a person's name:
Title (T): e.g. Dr. Mr, etc., “” if inapplicable or not available
Given Name:
affix: e.g. Mc or de or Mohd or”
Stem/Root: e.g. John
Soundex code: Soundex for of Stem
Family Name (Surname):
affix:
Stem/Root: e.g. Smith
Soundex code: Soundex for of Stem
Affix (A): e.g. Jr.
Qualification (Q): e.g. PhD, Dr, Prof. etc.
Culture: list of country names (cultural origin) where name could generally belong
e.g.[UK, US, Not found . . . ].
Gender: male/female/other
If any information is not present provide “”.
Avoid duplicate entries in list data type fields.
Ensure a word/token in name is either part of affix or stem within Given name.
Also ensure a word/token in name is either part of affix or stem within Surname name.
Also avoid duplicate entry between Given name and Surname.
The following is the person's name from which information should be extracted:
<<<
{person_name}
>>>
Only provide JSON structure as output. Do not include any other information.
An example for a final JSON is:
{Output Example}

Additional or alternative operations or procedures may be used in different embodiments.

In some embodiments, a text input (such as, e.g., party or entity information from which components may be extracted by an LLM) may describe an exchange of data over a computer network, the exchange of data involving the entity. For example, a text input that may be provided to an LLM or machine learning model for extracting text components may be or may include, e.g., a text description or narrative, or tabular data describing a computerized transaction involving the entity matching a watchlist entry or involved in a hit. An example input text may include, transaction data such as, e.g.: “Transaction ID: 001; Date: Feb. 24, 2025; Customer ID: C110; Customer Name: John Smith; Store Name: BestBuy; Transaction Amount: $150” and/or additional text fields or data items describing the entity involved in the transaction (e.g., John Smith) and matching a watchlist entry (e.g., an entry of John S. Smith, a USA government sanctioned individual). Additional or alternative text inputs and/or formats may be used in different embodiments.

For a nonlimiting, specific use case of a hit between input entity “Mr. Josep Vincent Esteve Giner” and a watchlist entity “Dr. Josep Jugo I Manzana” (also referred to as “HIT name”)—Tables 8-9 show an example data structures for name components that may be extracted (e.g., by an LLM) for an input entity and a hit/watchlist entity or name according to some embodiments of the invention:

TABLE 8

| Field | Party/entity Value |
|---|---|
| Affix | — |
| Title | Mr. |
| Qualification | — |
| Culture | [‘Spain’, ‘Catalonia’] |
| Given Name stem | Josep |
| Family Name stem | Manzana Jugo |
| Family Name affix | — |
| Gender | Male |

TABLE 9

| Field | HIT Value |
|---|---|
| Affix | — |
| Title | — |
| Qualification | Dr |
| Culture | [‘Spain’, ‘Catalonia’] |
| Given Name stem | Josep |
| Family Name stem | Jugo Manzana |
| Family Name affix | I |
| Gender | Male |

Table 10 shows example data structures or data frames which may be used to store embeddings for entity/party and HIT name components according to some embodiments of the invention:

TABLE 10

Party Name
Mr. Josep Manzana Jugo
HIT Name
Dr. Josep Jugo Manzana

| | Component | Embeddings |
|---|---|---|
| Party Affix | — | [0.010, 0.031, −0.015, . . . ] |
| Party Title | Mr | [0.024, −0.013, 0.002, . . . ] |
| Party Qualification | — | [0.010, 0.031, −0.015, . . . ] |
| Party Culture | [‘Spain’, | [0.005, 0.011, 0.029, . . . ] |
| | ‘Catalonia’] | |
| Party Given | Josep | [0.018, −0.012, 0.045, . . . ] |
| Name stem | | |
| Party Given | — | [0.010, 0.031, −0.015, . . . ] |
| Name affix | | |
| Party Family | Manzana | [0.001, 0.009, −0.023, . . . ] |
| Name stem | Jugo | |
| Party Family | — | [0.010, 0.031, −0.015, . . . ] |
| Name affix | | |
| Party Gender | Male | [0.030, −0.022, 0.010, . . . ] |
| HIT Affix | — | [0.010, 0.031, −0.015, . . . ] |
| HIT Title | Dr | [0.010, 0.031, −0.015, . . . ] |
| HIT Qualification | — | [0.005, 0.011, 0.029, . . . ] |
| HIT Culture | [‘Spain’, | [0.005, 0.011, 0.029, . . . ] |
| | ‘Catalonia’] | |
| HIT Given | Josep | [0.018, −0.012, 0.045, . . . ] |
| Name stem | | |
| HIT Given | — | [0.010, 0.031, −0.015, . . . ] |
| Name affix | | |
| HIT Family | Jugo | [0.018, −0.012, 0.045, . . . ] |
| Name stem | Manzana | |
| HIT Family | — | [0.010, 0.031, −0.015, . . . ] |
| Name affix | | |
| HIT Gender | Male | [0.030, −0.022, 0.010, . . . ] |

Table 11 shows example data structures or data frames which may be used to store similarity based features calculated according to some embodiments of the invention.

TABLE 11

| | |
|---|---|
| HIT key | 123 |
| Party Name | Mr. Josep Manzana Jugo |
| HIT Name | Dr. Josep Jugo Manzana |
| Affix Similarity | 1 |
| Title Similarity | 0.4 |
| Qualification Similarity | 0.1 |
| Culture Similarity | 1 |
| Given Name stem | 1 |
| Similarity | |
| Given Name affix | 1 |
| Similarity | |
| Family Name stem | 0.5 |
| Similarity | |
| Family Name affix | 0.3 |
| Similarity | |
| Gender Similarity | 1 |

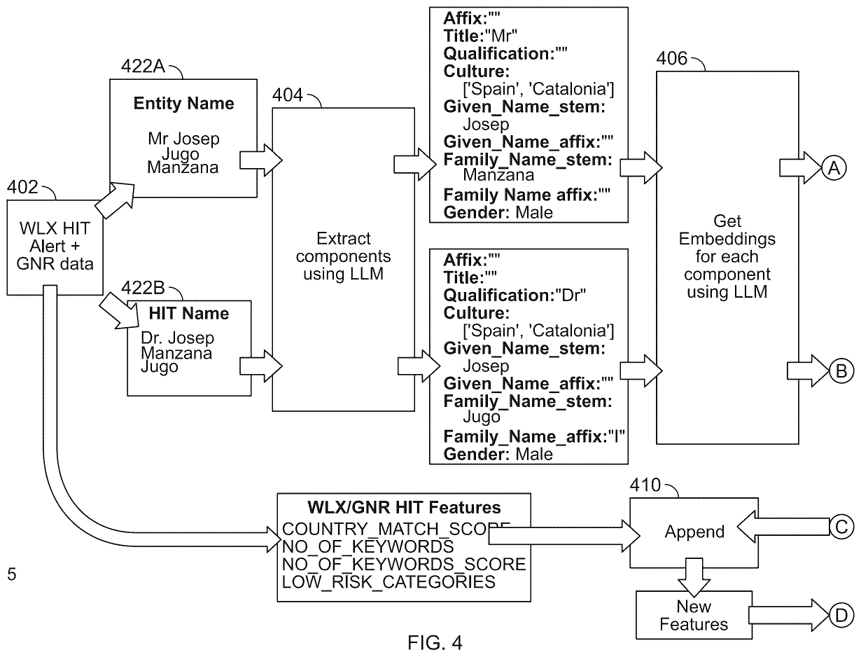

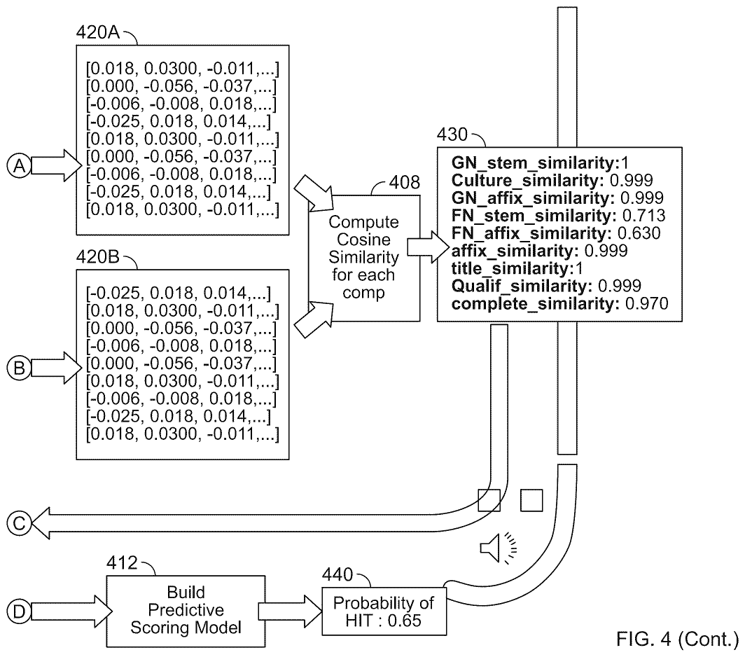

FIG. 4 shows an example process for generating a similarity score based features according to some embodiments of the invention.

In some embodiments, similarity scores may be calculated using one or more vector embeddings for one or more of the extracted text components.

For example, for similarity score calculation, some embodiments may use a cosine similarity formula, e.g., according to Eq. 1:

cosine_similarity=(Σ(Aᵢ×Bᵢ))/(√(Σ(Aᵢ²))×√(Σ(Bᵢ²)))) (Eq. 1)

Where A and B are vectors or numerical embeddings (such as for example vector embeddings generated for name or entity name/identifier text components or segments using an embedding model or “third machine learning model”), and the summations are over the dimensions i of these vectors. Additional or alternative similarity formulas or metrics may be used in different embodiments.

Some embodiments may include training a second machine learning model using one or more similarity scores, the one or more similarity scores calculated for: one or more of the extracted text components, and one or more corresponding reference components. Some embodiments may compute one or more predictive scores by the trained second machine learning model, where computed predictive scores may be or may include a probability for a true match between one or more of the extracted text components and one or more of the reference components. Some embodiments may include training the second machine learning model using e.g., a count value for the extracted text components, and a number of the similarity scores below a predetermined threshold.

An example algorithm for generating similarity-score-based features which may be used for training a predictive ML model (or which may enhance an existing dataset for training the predictive model, which may be, e.g., a “second machine learning model” or a model separate and distinct from the ML model used for extracting text or name components and/or from an ML used for generating embedding for components) is provided in Table 12.

TABLE 12
WLX HIT Alert + GNR Data 402:
Input Data: This block represents an input comprising, e.g.:
Entity Name: The primary name involved in the alert, e.g., John Smith.
HIT or reference Name: The matched name, or a reference record in a
watchlist matched with the entity name to potentially trigger an alert or hit,
e.g., J. S. Smith.
These names may be processed further to analyze their components and relevance.
Identify/Extract Components Using LLM 404:
Text components or segments that may be extracted by some embodiments may
include, e.g.: a qualification, a country's name, a name, and a gender. In some
embodiments, the Entity Name and HIT Name may be sent or passed to an LLM to
extract structured components, such as for example:
Affix
Title
Qualification
Culture (probable countries associated with the name)
Given Name (stem and affix)
Family Name (stem and affix)
Gender
This operation may standardize the data for comparison and further processing.
Get Embeddings for Each Component Using LLM 406:
Each extracted name component may be converted into numerical embeddings
420A-B (where 420A describes, e.g., entity name 422A, and 420B describes
reference name or hit name 422B matched with the entity) using an embedding
model or LLM.
These embeddings may capture the semantic representation of the name
components.
Compute Cosine Similarity for Each Component 408:
Cosine similarity may be computed between corresponding numerical embeddings
of the Entity Name and HIT Name. This may have the output or effect of creating
similarity scores calculated for: one or more of the extracted text components, and
one or more corresponding reference components.
Similarities may be calculated or computed for text components or segments such
as, e.g.:
Given Name (e.g.,), e.g., Cosine_similarity(X₁, X₂,) = Cosine_similarity
[John], [J. S.])
Family Name (stem and affix), e.g., Cosine_similarity (Smith, Smith).
Title, e.g., Cosine_similarity (Mr., Dr.,)
Qualification, e.g., Cosine_similarity (Scientist, Chemist)
Culture, e.g., Cosine_similarity (United Kingdom, England).
Results may be computer and/or displayed as similarity scores (e.g.,
Given_Name_stem_similarity: 0.8, Culture_similarity: 0.7).
WLX/GNR HIT Features 430:
Features (such as, e.g., similarity features) may be computed or derived based on
numerical embeddings for text components/segments extracted using an LLM and for
reference components/segments, including, for example:
COUNTRY_MATCH_SCORE: Match score based on culture, or a
similarity score for numerical embeddings of extracted/reference components or
segments describing a country or culture (e.g., extracted = United States,
reference = USA, COUNTRY_MATCH_SCORE = 0.9).
A number of the similarity scores below a predetermined threshold T: for
name components of an entity, two similarity score may be computed, e.g.,
COUNTRY_MATCH_SCORE, and a similarity score for first names, such as, e.g.,
Similarity (“John”, “Max”) = 0.3, and the like, which may be below a threshold
T = 0.7. The number of scores below a threshold for a name/hit pair may be used a
similarity/LLM based feature that may be used to train a predictive model
according to some embodiments of the invention.
NO_OF_KEYWORDS: Number of extracted components or keywords, or
a count value for the extracted text components (e.g., (1) John (2) Smith (3) PhD
may correspond to 3 components, or to a count value or NO_OF_KEYWORDS = 3).
NO_OF_KEYWORDS_SCORE: Scoring based on keyword relevance
(where relevant may for example be calculated using, e.g., term frequency-inverse
document frequency (TF-IDF) scores or metrics).
LOW_RISK_CATEGORIES: Identifying low-risk matches.
These features may then be appended to the processed data for predictive analysis.
Append New Features 410:
The extracted similarity scores and additional WLX/GNR HIT features may be
combined into a unified feature set, which may be used for modeling or for training
a predictive model.
Build/Train Predictive Scoring Model 412:
A predictive scoring model (e.g., a second ML model, which may be separate and
distinct from the LLM extracting text components) may be built using the combined
feature set including the similarity-score-based-features calculated for
extracted/identified and reference text components.
The model may compute or output a predictive score 440, which may be or may
include a HIT probability, or a probability that the match is a true hit, and that two
names or identifiers (entity name and HIT name: John Smith and J. S. Smith) refer
to a single entity (e.g., True Hit Probability P = 0.65), which may indicate that the
match may be accurate and relevant (and for example should not be ignored).

Additional or alternative operations may be used in different embodiments.

In some embodiments, a NO_OF_KEYWORDS score may count or may represent/describe a number of different keywords that are associated with the hit, or with entities associated with or that generated the hit. For example, the NO_OF_KEYWORDS score may be calculated as, e.g. the number of different watch lists that the listed entity, or the hit name, appears on. For example, a hit may be generated or found for a hit name or watchlist entry “ABC Company”. The NO_OF_KEYWORDS score may be defined as, or configured to, add 0 points to the hit score (which may be, e.g., a score calculated without considering a NO_OF_KEYWORDS score)—if the hit name or watchlist entry or entity is associated with five or less keywords, or if the watchlist includes less than 5 entries. The watchlist including the hit name includes the following four entries or hit names: “OFAC”, “PEPSDT”, “SDGT”, and “SDNT”, and therefore the NO_OF_KEYWORDS score may equal zero. For a hit name associated with above 5 keywords or found in a watchlist with more than 5 entries, some embodiments may add N points (e.g., N=5) for each entity/entry above 5 entities/entries. Such an example definition of a NO_OF_KEYWORDS score or factor may be to increase the hit score in case there are multiple keywords (or watchlist names) associated with the hit (as in some example use cases, multiple keywords may, e.g., reflect a greater risk for the relevant watchlist or hit).

A LOW_RISK_CATEGORIES score or factor may count or represent watch list categories that appear in low risk categories list (which may be defined in an appropriate configurations or preferences file), Entries in such a list may be associated with the entity name, and/or hit name, and/or with the watchlist including the hit name. In some embodiments, this score or factor may be defined or configured to decrease the hit score for hits associated with pre-known, low risk categories. For example, a hit may be generated for the entity/name “John Smith”. This name is associated with a specific low risk category “common names” (e.g., as there are many people named John Smith, and the likelihood of a true hit may be low). As a result, the LOW_RISK_CATEGORIES score or factor may be applied, and the hit score for the relevant hit may be reduced by a predetermined amount or by M points (e.g., M=5).

Additional scores or factors may be calculated in different embodiments.

Some embodiments may train an ML model or a predictive scoring model (e.g., a second ML model, which may be separate and distinct from the LLM extracting text components) to predict or compute a true hit probability, or a probability that a hit or match between two entity names or identifiers is true, and not a false positive (where the two names refer, in fact, to two separate and distinct, unrelated entities- and not to a single entity).

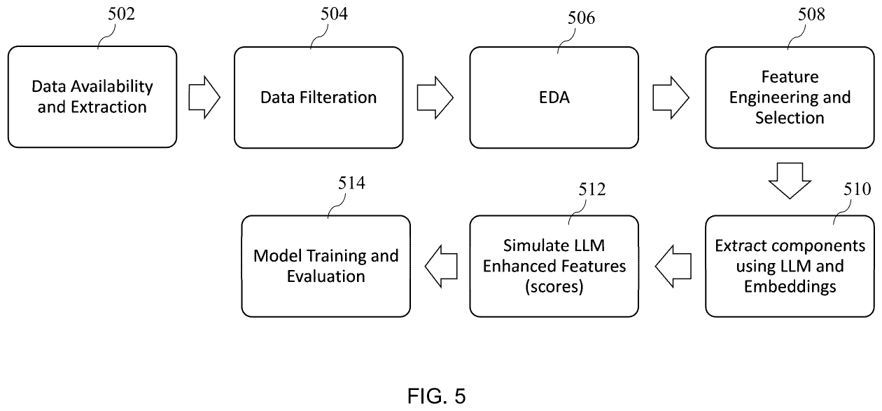

FIG. 5 shows an example data processing and model training process according to some embodiments of the invention.

Data availability and extraction 502 may include, for example:
Identify tenants: some embodiments may identify different tenants or users from, or corresponding to, a given “base activity” (which may refer to a transaction type or to a different screening criterion to define or screen a subset of records included in a given dataset). The first step may be to identify all tenants (e.g., users or accounts, with corresponding user/account identifiers and/or additional details) documented in the system, for which data describing a given base activity or filtering/screening criterion may be extracted.
Data availability/data extraction (for example from a database of the WLX platform by Actimize Ltd., which may be referred to as “WLX database”): to conduct analysis, data (such as, e.g., database records or tabular data illustrated in Tables 8-9) may be extracted from an WLX database, spanning a predefine timeframe (of, e.g., 3 to 6 months, or one year from the present day).
Data collection from S3: data items or elements that may be used for analysis may be sourced or extracted from S3, where information from various clients, users, or customers may be stored. This data may undergo filtering processes to extract relevant information, for example based on specific conditions or criteria.
Recent data utilization: some embodiments may prioritize the use of more recent data generated or shared by users or customers. For example, recent historical data transfer or transaction data (such as for example data generated or collected within a predefined or predetermined time period of 3 months prior to the current date) may be augmented or enriched with transaction attributes or features—which may, e.g., computed using a fraud detection software or platform such as for example the Actimize Watch platform for financial crime prevention—to create a comprehensive and informative dataset for model development and analysis. Additional or alternative components may be used for feature calculation or augmentations according to different embodiments. The resulting dataset may be used as a training dataset for machine learning models or LLMs for fraud detections and may serve as the foundation for developing advanced analytics, for example within the Actimize platform or a different platform, software or framework.

Data filtration 504 may include, for example:
Data cleaning for ensuring data quality: quality of input data and the accuracy of data processing may be paramount for building high-quality models. To achieve this, data cleaning procedures may be employed to eliminate any unreliable or inconsistent data. Additionally, certain input data items or points may require transformation into numerical values to facilitate their incorporation into models and/or equations.
Exclusion of filtered transactions or data items/points: data items (corresponding to or describing, e.g., data transfers or computerized transactions) that have undergone filtering processes and were deemed unnecessary for model development may be excluded from consideration. Filters, in this context, may represent or refer to technical/logical rules that may be applied to input data (e.g., to evaluate incoming transaction data). The purpose of these filter rules may be to streamline transaction processing by determining whether a transaction requires further assessment, or whether it should be used in training a machine learning model (or, e.g., whether it represents a data point which may introduce errors or statistical biases, and which should therefore not be used in training a model). The process may involve gathering data from various sources, extracting relevant information based on predefined criteria, including a comprehensive set of features for model development, and applying filtering rules to streamline transaction processing before model evaluation. This approach may ensure that the machine learning model is trained on a robust dataset, optimizing its effectiveness in fraud detection and prevention.
Recent data utilization and prioritizing recent data may be applied in this operation as well.
Quality control and data validation: to maintain the integrity of the model development process, quality control (QC) or data validation procedures or checks may be performed on, or may be applied to the dataset, or to sampled data items or data sampled for training. These checks may aim to identify any anomalies or issues that could potentially compromise the quality or performance of the model, if trained using the sampled data. Any issues detected during the data gathering phase may be addressed promptly to ensure the robustness and reliability of the model. Utilization of recent data combined with attributes (such as for example calculated using the Actimize Watch suite, or a different component) may allow for the creation of more advanced models. Ensuring data quality through cleaning procedures and validation checks may be essential for developing accurate and reliable fraud detection models (which may be utilized or used as part of fraud detection programs or platforms such as, e.g., the Actimize Watch platform).

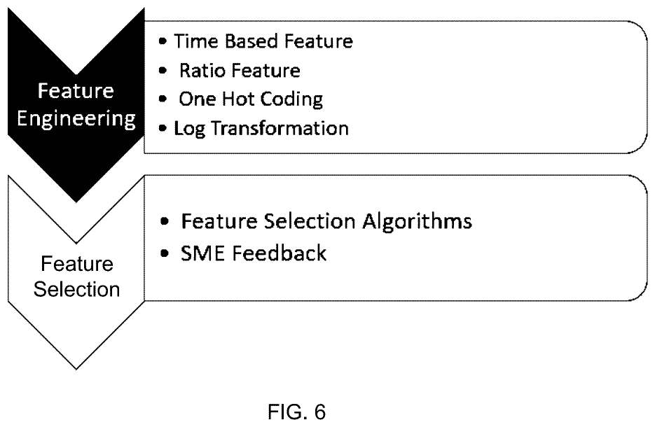

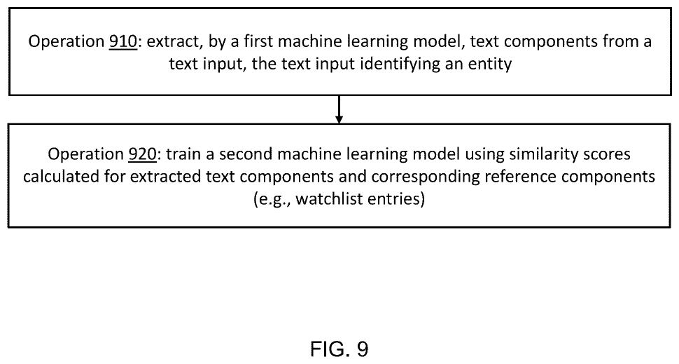

Exploratory Data Analysis (EDA) 506 may include several procedures and/or operations for example data cleaning, which may include, e.g.:
Null values: this operation may involve identifying and handling missing feature/attribute values (such as for example values that may be missing in some columns of a database entry such as illustrated in FIGS. 6, 9), fields, or information within the dataset. Missing values may adversely affect model performance, so techniques such as, e.g., imputation (filling missing values with estimated ones) or deletion (removing rows or columns with missing values) may be applied.
Zero variance: features or attributes having zero variance, or that have constant values across all samples in the dataset, may be identified and removed from the dataset. These features may not contribute any meaningful information to the model and may be safely dropped.
High cardinality: features with having more categories or many different values across the dataset (such as, e.g., more than a threshold of 50 different values) may be identified and removed from the dataset. High-cardinality features may create a large number of dummy variables and reduce model performance.

As well as basic EDA, which may include, e.g.:
Hit distribution: some embodiments may check a hit distribution, or data points included in the dataset associated with true hits, across the given time period to ensure a sufficient amount of information describing hits is available for model training. Some embodiments may impose restrictions, conditions or criteria for hits and their distribution across the specified or relevant time period.
Feature distribution: after data cleaning, some embodiments may analyze the feature distribution for each variable or field in the dataset, for example using the following conditions:
For a numerical feature, or for a feature including numerical values, calculate parameters for feature values such as, e.g., minimum value, maximum value, mean/average value, standard deviation (SD), distinct value count, and the like, based on all values existing in the dataset.
For a categorical or binary feature or attribute (having, e.g., only 0 and 1 as possible values)—some embodiments may calculate a hit percentage or rate and non-hit percentage or rate for each binary value of the categorical feature in the dataset (such as, e.g., 50% of the data points having feature V-O are associated with fraud; 33% of the data points having feature V=1 are associated with fraud).

In some embodiments, EDA 506 may be followed by additional operations such as, e.g., feature engineering and selection 508, component extraction (e.g., of name components) using LLMs and embeddings 510, calculation or simulation of LLM-enhanced features or scores 512, and model training 514 (which may be performed, e.g., using the hit-based features or attributes, or using LLM enhanced features). Some nonlimiting examples for these steps are described, e.g., with regard to different figures herein. Additional or alternative operations may be used in different embodiments of the invention.

FIG. 6 illustrates example feature engineering and selection processes according to some embodiments of the invention.

Feature engineering and/or features using in data labeling and hit enrichment according to some embodiments may include, e.g.:
Time based features, which may for example include a “Date/Duration” features (e.g., the date/time on which a transaction took place, as may be described, e.g., using timestamps in transaction data). Additional variables or time based features may include, e.g., “Weekdays/Weekend” (calculate the date column is fall on weekdays or weekend), and “Time Bucket” (which may be derived from a time bucket for transactions, for example whether the transaction is happing or taking place in morning, afternoon, evening, night, and the like). In some example time based features, one date column may be used as a reference to which a given transaction date may be compared (and features or attributes may be calculated, e.g., as a difference between two dates, and/or values, points, or columns representing different dates in a table or database such as, e.g., illustrated in the figures herein).
Ratio features, which may be, e.g., calculated ratios between a plurality features or values. Such features may sometime significant insight to individual features (for example: a ratio for “amount” and “balance” features may be informative in addition to each of these features when considered in isolation).
One hot encoding may be used to create new (binary) columns, indicating the presence of each possible value from the original categorical data.
Log transformation: in this transformation technique each variable may be replaced with its logarithm which may be helpful to make feature distribution more symmetric and to reduce skewness and noise.

A feature selection algorithm according to some embodiments may include, for example:
XGBoost: The feature-importance-from-baseline XGBoost model may be used to provide a significant list of features, or a list of the most statistically significant features in a dataset.
The Boruta algorithm may allow creating a ranking for features, from the most to the least impactful or statistically significant or informative.
The Min-Redundancy Max-Relevance (MrMr) algorithm may rank features based on their importance in predicting a target variable, where “importance” may be quantified or calculated according to or based on relevance and redundancy components.
Subject matter expert (SME) feedback: A final list of the features may be reviewed by an SME and based on their feedback the final list of features may adjusted, features may be added/omitted, and the like.
   Additional or alternative operations or components may be used in different feature engineering or selection processes according to different embodiments.

In some embodiments, computerized procedures and operations such as for example described with regard to FIGS. 3-4 may be used to train the predictive ML model or the second machine learning model for computing predictive scores or probabilities for a true match by the second machine learning model.

An example training dataset according to some embodiments may be or may include a labeled dataset including entity data (such as, e.g., tabular data as in Tables 8-9) labeled as, e.g., “true hits” (for entities found to be a true hit) and “false hits” (entities found to be false positives). For example, the labeled training dataset may include, for example entity information for a plurality of entities (where for each entity, features such as, e.g., first name, family name, affix, address, etc., may be provided as input) and a plurality of attributes/features for each entity, which may include similarity score based features calculated using text components. In some embodiments, features used in machine learning model training may be weighted (e.g., by an analyst or model designer) to reflect their relative importance in subsequent predictions by the model. Example features and weights that may be included in a labeled training dataset according to some embodiments is provided in Table 13:

TABLE 13

| | | Weight/ |
|---|---|---|
| Feature Name | Feature Description | Importance |
| IS_SIP | Is a Special Interest Person | 0.5428645 |
| PARTY_COUNTRIES_ISIN_Not Known | Party Country is not known | 0.09612368 |
| WLX_CFSF_MATCHINGENGINE_SC | Matching Engine Score | 0.08473027 |
| WLX_CFSF_COUNTRYMATCH_SC | Country Match Score | 0.06281212 |
| HIT_CATEGORIES_ISIN_Special | Hit Category is part of Special | 0.04732653 |
| Interest Person (SIP)-Sanctions Lists | Interest Person - Sanctions Lists | |
| HIT_COUNTRIES_ISIN_Spain | Hit Country is Spain | 0.026006255 |
| WLX_CFSF_PERSONEXACTMATCH_SC | Person is exact match score | 0.015629748 |
| PARTY_COUNTRIES_ISIN_Iran | Party Country is Iran | 0.015194251 |
| INPUT_MATCHED_FIELD | | 0.014467163 |
| PARTY_COUNTRIES_ISIN_Spain | Party Country is Spain | 0.013146214 |
| WLX_CFSF_IDMATCH_SC | ID is matching score | 0.012853155 |
| PARTY_ALIAS_COUNT | Party has a non zero alias count | 0.011386416 |
| name_sim | Name is similar | 0.007370654 |
| HIT_COUNTRIES_ISIN_Brazil | Hit Country is Brazil | 0.00617713 |
| Given_Name_affix_sim | Given Name is similar | 0.005860894 |
| WLX_CFSF_INITIALHITSNUMBER_VL | Initial Hits score | 0.005154157 |
| Family_Name_stem_emb_sim | Family Name is similar | 0.00512324 |
| PARTY_COUNTRIES_ISIN_Brazil | Party Country is Brazil | 0.004487308 |
| IS_PEP | Is politically exposed person | 0.00429498 |
| Culture_sim | Similar culture | 0.003273875 |
| HIT_CATEGORIES_ISIN_Special | Hit Category is part of Special | 0 |
| Interest Person (SIP)-Other Official Lists | Interest Person - Other Official Lists | |
| PARTY_YEAR_OF_BIRTH | Party's Year of Brith | 0 |
| PARTY_ALIASES_PRESENT | Party has aliases | 0 |
| PARTY_COUNTRIES_ISIN_others | Party Country is “Others” | 0 |
| IS_SIE | Is a Special Interest Entity/Business | 0 |
| HIT_COUNTRIES_ISIN_Iran | Hit Country is Iran | 0 |
| Qualification_sim | Name qualifier is similar | 0 |
| title_emb_sim | Name Title is similar | 0 |
| PARTY_COUNTRIES_ISIN_China | Party Country is China | 0 |

Additional or alternative features and/or weights may be used in different embodiments.

A Model Training and Evaluation according to some embodiments may include, for example, some or all of the operations specified in Table 14:

TABLE 14

| | |
|---|---|
| 1. | Split transactional data, including newly created LLM-based features (such as for |
| | example features based on similarity scores between name components), into |
| | training and validation sets. |
| 2. | Select appropriate (e.g., traditional) predictive machine learning models and/or |
| | algorithms, such as for example the Extreme Gradient Boosting (XGB boost) tree- |
| | based algorithm and/or additional models and algorithms. |
| 3. | Train the selected models on the training data, using the hit label as the target |
| | variable. |
| 4. | Evaluate the trained models' performance on the validation set. |
| 5. | Obtain a separate test set or hold-out data that the models have not been exposed |
| | to during training. |
| 6. | Evaluate the selected best-performing predictive model on the test set, calculating |
| | the same performance metrics used on the validation set. |
| 7. | Assess the best performing model's interpretability and explainability, particularly |
| | with respect to the contributions of LLM based features to the performance and/or |
| | accuracy of the model. |

According to some embodiments, XGBoost models may perform predictive scoring operations, e.g., due to their superior ability to handle complex data and minimizes overfitting in a computationally efficient manner. XGBoost or XGBoost based models may provide higher accuracy and robust performance compared to alternative machine learning models and/or algorithms (such as for example conventional random forests or standard gradient boosting methods). The computational efficiency and accuracy provided by XGBoost based models may prove particularly useful for large and complex datasets or databases including, e.g., millions of entries—which may prove virtually impossible to analyze using prior machine learning technologies with sufficient accuracy.

In some embodiments, Llama-family models (such as for example the Llama 3.1, Llama 3.2, and Llama 3.3 LLMs) may perform name component extraction operations—for example using appropriate commands or prompts. This family of LLMs may offer superior performance, e.g., due to the models' strong contextual understanding and ability to generate structured outputs based on natural language prompts. OpenAI Embedding API may generate embeddings—as this embedding generation tool has been shown to produce statistically robust, high-dimensional embeddings numeric representations—which may result in superior accuracy in similarity calculations/comparisons involving extracted name components compared to alternatives. Additional or alternative machine learning models and/or LLMs may be used in different embodiments.

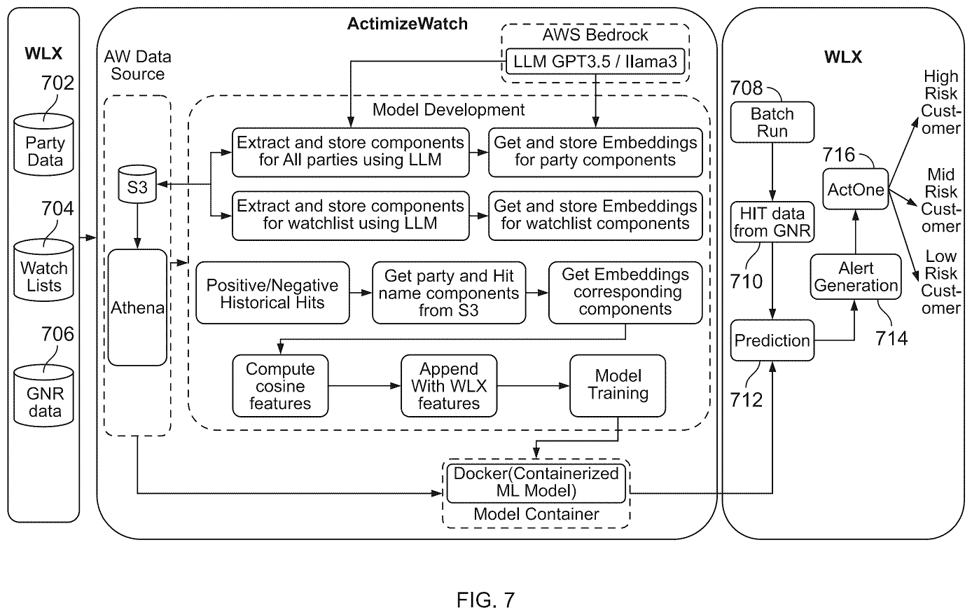

FIG. 7 shows an example implementation of similarity based features in a fraud detection system according to some embodiments of the invention.

In addition to components discussed with regard to FIG. 2, some embodiments may include additional components or elements which may, for example: retrieve or receive data items used for entity recognition and/or for model training, trigger or initiate the recognition process, and/or which may take automated actions based on recognition or detection results.

In some embodiments, the system may extract entity, party, or customer static information 702, watchlists 704, GNR data 706, and the like. Extracted data may be sent to an appropriate software system or platform such as, e.g., the Actimize Watch platform where it may be stored in an appropriate AW Data Storage block. In some embodiments, extracted data may include, for example, fields, entries, or data items of information as specified in Table 15:

TABLE 15
Identifying Information:

| | |
|---|---|
| • | Full Name: All given names and surnames. |
| • | Aliases/Nicknames: Alternative names used by the individual. |
| • | Date of Birth: Birthdate for age verification and potential identification. |
| • | Place of Birth: City, state, or country of birth. |
| • | Nationality: Country of citizenship. |
| • | Passport Number/ID Number: Unique identifiers for individuals. |

Contact Information:

| | |
|---|---|
| • | Address: Current and previous addresses for location tracking. |
| • | Phone Number: Mobile, home, and work phone numbers. |
| • | Email Address: Personal and professional email addresses. |

Financial Information:

| | |
|---|---|
| • | Bank Account Numbers: Associated bank accounts for financial transactions. |
| • | Credit Card Numbers: Credit card details for potential fraud detection. |
| • | Tax Identification Numbers: Unique tax identifiers for individuals or entities. |

Other Relevant Information:

| | |
|---|---|
| • | Employer/Occupation: Current and past employment details. |
| • | Education: Educational background and institutions attended. |
| • | Social Media Profiles: Usernames and links to social media accounts. |
| • | Vehicle Information: Vehicle registration details, if applicable. |
| • | Travel History: Records of travel destinations and dates. |
| • | Associated Entities: Companies, organizations, or individuals connected to the watchlist |
| | entry. |
| • | Reason for Inclusion: Explanation of why the individual or entity is on a given watchlist |
| | (e.g., sanctions, PEP status, adverse media). |
| • | Date Added/Last Updated: Timestamps for when an entry was added or last modified. |

In some embodiments, model containerization may involve deploying trained machine learning models in a production environment using containerization technologies such as, for example, the Docker framework. This approach allows the model, along with all its dependencies, to be packaged into a lightweight, portable unit known as a container. Containers may provide isolation, ensuring that the model's environment remains consistent and predictable across different systems, regardless of the underlying server configuration. This consistency is crucial for maintaining the reliability and performance of the model when handling real-time data exchanges or transactions.

Docker-based containerization according to some embodiments may have several, nonlimiting advantages:
Isolation: each container may run in isolation from other processes on the system, ensuring the model's environment remains consistent and predictable regardless of the underlying server configuration.
Portability: Docker containers are self-contained, making it easy to deploy the model across different environments (development, testing, production) without worrying about compatibility issues.
Scalability: Docker Containers are lightweight and can be easily scaled up or down based on processing demands. This may allow for efficient resource utilization, especially when handling high volumes of real-time transactions.

Once models are containerized, they may be deployed in a production environment. This may involve using container orchestration tools such as for example the Kubernetes environment to manage the lifecycle of the containers, ensuring they run smoothly and are scaled appropriately, e.g., to handle compute and network traffic.

In production environments, name screening processes according to some embodiments may be containerized. This means the entire workflow, from feature engineering to model prediction, may be packaged into a self-contained unit. A containerized environment may ensure consistency and portability across different deployment environments.

Once deployed, the container may receive customer data as input. It may execute the feature engineering steps, transforming raw data into a format suitable for the machine learning model. Subsequently, the model (e.g., the predictive model or the second model) may generate a prediction, assessing the risk associated with an input name or identifier. The container may output a name screening score, providing a quantifiable measure of risk for each customer. A containerized approach may streamline the name screening process, enabling efficient and scalable deployment and maintenance while ensuring consistent performance across different environments.

Batch Run 708: This block may refer to the initiation of the risk assessment process. It may involve scheduled tasks or manual triggers to start the analysis, e.g., on multiple records, entries, or hits.

HIT data (e.g., from GNR) 710: the system may receive data, such as for example GNR data, from an external source or remote computer, which may be used as part of the analysis.

Prediction 712: the system may use deployed machine learning models to analyze the HIT data and predict the risk level of, or calculate/compute a predictive score for, each entity or customer of a plurality of entities/customers (e.g., for which HIT data or reference entries are found).

Alert Generation 714: Based on the predicted risk levels, the system may generate alerts for customers who fall into high-risk categories. In some embodiments, alerts may be customized, categorized or classified according to different risk thresholds or level, and different automated actions may be taken for each alert category.

ActOne 716: this block may refer to automated, computerized actions taken in response to generated alerts. This may include or involve various operations such as, for example:
Escalating high-risk cases to relevant review teams for further investigation;
Triggering automated responses or notifications and sending/transmitting notification to a remote computer, or to a computer separate from the system performing the analysis or running ML models and connected to the system over a data network (such as, e.g., a computer system operated by a system administrator or security officer);
Implementing preventive measures to mitigate potential risks, such as for example preventing or delaying a data transfer or computerized transaction;

In some embodiments, entities or customers may be classified into different risk categories for example based on prediction and alert generation processes. Additional or alternative elements and operations may be used in different embodiments.

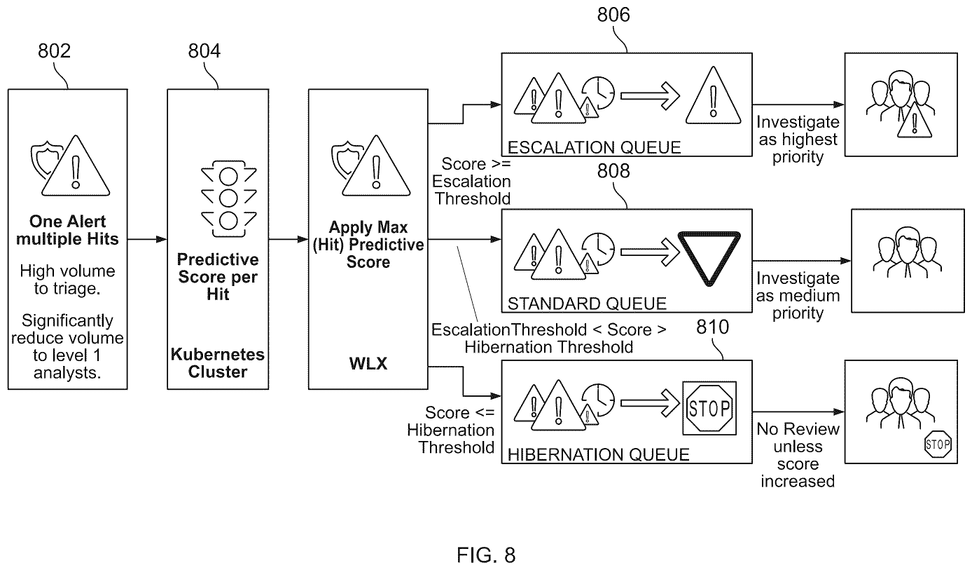

FIG. 8 shows an example alert generation process according to some embodiments of the invention.

In some embodiments automated actions may be performed based on one or more alerts, the one or more alerts generated based on one or more of the computed predictive scores, wherein the alerts are categorized into a plurality of risk levels.

An example alert generation process according to some embodiments of the invention is described in Table 16.

TABLE 16

| • | Alert Generation 802: An alert may be triggered by a name matching system (e.g., based | |
|---|---|---|
| | on a preliminary match or matches between a name or identifier of an entity and a watchlist | |
| | entry) according to some embodiments of the invention, e.g., running on a Kubernetes | |
| | cluster. | |
| • | Predictive Score Calculation 804: The system may analyze the alert and may calculate or | |
| | compute a predictive score or scores for the match, hit, or alert based on historical data, | |
| | and, for example, using a predictive model or “second machine learning model” trained | |
| | using LLM-based or similarity score-based features. The predictive score may be or may | |
| | include a probability for a true match or true hit between text components (e.g., entity | |
| | names or identifiers extracted using an LLM) and one or more of the reference components | |
| | (e.g., watchlist entries). | |
| • | Queue Assignment: The alert (which may be described using or be associated with, in some | |
| | embodiments, a highest or maximum predictive score calculated for a plurality of hits or | |
| | matches for a single entity or party) may be categorized or placed into one of the three | |
| | queues or risk levels based on the following criteria: | |
| | 1. | Escalation Queue 806: for a predictive score above an ″Escalation Threshold″ (e.g., |
| | | a threshold real hit probability or score of T1=0.9), alerts may be determined “high |
| | | risk”, or may be categorized as “high risk level” alerts - which may be investigated |
| | | as the highest priority. |
| | | Automated Blocking: Customers or users associated with the alert may |
| | | automatically be flagged with probability score in the system and blocked |
| | | for performing another transaction. |
| | 2. | Standard Queue 808: for a predictive score between the ″Escalation Threshold″ and |
| | | ″Hibernation Threshold″ (e.g., between T1=0.9 and T2=0.5), alerts may be |
| | | categorized as “medium risk level”, may be investigated as medium priority. |
| | | Automated Blocking: Users or customers associated with the alert may be |
| | | temporarily put on hold. |
| | 3. | Hibernation Queue 810: for a predictive score below the ″Hibernation Threshold″ |

```
(e.g., below T2=0.5), alerts may be categorized as “low risk” and may not be
reviewed unless the predictive score increases for subsequent analyses (e.g., of
subsequent transactions).
  No blocking/suspending actions may be taken, but the system may monitor
  the activity of the relevant user or entity for future score fluctuations.
```

Additional or alternative alert generation processes and procedures may be used in different embodiments.

Some embodiments may include performing one or more automated actions, the automated actions comprising: blocking an exchange of data, delaying an exchange of data, and permitting an exchange of data, wherein the one or more automated actions are performed based on one or more of the computed predictive scores.

Alert generation: in some embodiments, if a calculated probability or predictive score of a true hit is greater than a threshold (e.g., a threshold T=0.7) the system may generate an alert. Depending on or based on the severity of the score (e.g., a calculated or output true hit probability) or corresponding alerts and/or pre-configured rules, the system might automatically execute, perform, or take automated actions based on the predictive score computed by the predictive model such as, e.g.:
Allow transaction: this may represent or correspond to the ideal scenario where the score is below the threshold, indicating the hit is unlikely to be a real hit. A pending transaction or data transfer (in which the relevant entity or user is involved) may be processed and allowed or permitted to proceed and be performed without restrictions.
Decline transaction: this may occur when the score is significantly above the threshold (e.g., at least 0.2 above threshold T: for example a calculated score or probability of 0.9>T=0.7), indicative of a high likelihood of a true hit. The system may automatically decline or block the transaction or data transfer, e.g., to prevent forbidden or illegal financial activity.
Delay transaction: this may happen for transactions with scores exceeding threshold T (but perhaps not as high as the automatic decline threshold: e.g., if T is exceeded by an amount X>0.2). The transaction may be flagged as suspicious, but the system may delay and hold it for a predetermined time period (e.g., 2 days), e.g., to allow an analyst to review the details before making a final decision whether to allow or decline the transaction.
   In some embodiments, all transactions or data transfers for which calculated scores or probabilities exceed threshold T may result in an alert being generated. The system may assign different severity levels to the alerts based on the perceived risk and different automated actions may be taken. Additional or alternative automated actions, thresholds and alerts may be used in different embodiments.

FIG. 9 shows an example process for machine learning based fraud detection according to some embodiments of the invention. In operation 910, some embodiments may extract, by a first machine learning model (such as for example an LLM), a plurality of text components (such as, e.g., names, titles, qualification, and more) from a text input, where the text input identifies an entity (the text input may, for example, describe an exchange of data or computerized transaction involving or specifying a user or entity, which may be provided as part of or together with a prompt to the LLM for component extraction). Some embodiments may train a second machine learning model (which may be, e.g., a traditional machine learning model separate and distinct from the LLM used for text component extraction) using similarity scores (calculated, e.g., using a cosine similarity formula) calculated for extracted text components (such as, e.g., entity names, titles, etc., extracted by the LLM) and corresponding reference text components or segments (such as, e.g., watchlist entries, sanctioned entities, and the like; operation 920). Additional or alternative operations may be used in different embodiments.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method of machine learning based entity recognition and data verification, comprising, using one or more computer processors:
extracting, by a first machine learning model comprising a large language model (LLM), one or more text components from a text input, the text input identifying an entity; and
training a second machine learning model, separate and distinct from the first machine learning model, using one or more similarity scores, the one or more similarity scores calculated for: one or more of the extracted text components, and one or more corresponding reference components from a watchlist of entities.

2. The method of claim 1, further comprising:
computing one or more predictive probability scores by the trained second machine learning model, wherein one or more of the computed predictive probability scores comprise a probability for a true match between the one or more of the extracted text components and one or more of the corresponding reference components, indicating whether the text input and the reference component refer to a single, real-world entity; and
performing one or more automated actions, the automated actions comprising: blocking an exchange of data, delaying an exchange of data, and permitting an exchange of data, wherein the one or more automated actions are performed based on the one or more of the computed predictive probability scores.

3. The method of claim 2, wherein the probability for the true match distinguishes true entity matches from false positive matches, wherein the false positive matches arise when two names refer to different real-world entities despite appearing similar.

4. The method of claim 2, wherein the one or more automated actions are performed based on one or more alerts, the one or more alerts generated based on one or more of the computed predictive probability scores, wherein the alerts are categorized into a plurality of risk levels, and wherein each risk level corresponds to a risk threshold applied to the predictive probability scores, the risk thresholds defining an escalation queue for a first risk level, a standard queue for a second risk level, and a hibernation queue for a third risk level.

5. The method of claim 1, wherein the one or more similarity scores are calculated using one or more vector embeddings for the one or more of the extracted text components, the one or more vector embeddings computed using a third machine learning model that is an embedding model separate and distinct from both the first machine learning model and the second machine learning model, wherein the vector embeddings encode semantic representations of the extracted text components.

6. The method of claim 1, wherein the text input describes an exchange of data over a computer network, the exchange of data involving the entity, wherein the one or more of the extracted text components comprises one or more of: a qualification, a country's name, a name, and a gender, and wherein the watchlist of entities is maintained for regulatory compliance screening, the watchlist of entities comprising at least one of a sanctions list, a politically exposed persons (PEP) list, or an adverse media list.

7. The method of claim 1, further comprising training the second machine learning model using one or more of: a count value for the extracted text components, and a number of the similarity scores below a predetermined threshold, wherein the second machine learning model is a gradient boosting model and a labeled training dataset for training the second machine learning model comprises historical entity matching records labeled as true matches or false positives.

8. A computerized system for machine learning based entity recognition and data verification, comprising:
a memory; and
one or more processors configured to:
extract, by a first machine learning model comprising a large language model (LLM), one or more text components from a text input, the text input identifying an entity; and
train a second machine learning model, separate and distinct from the first machine learning model, using one or more similarity scores, the one or more similarity scores calculated for: one or more of the extracted text components, and one or more corresponding reference components from a watchlist of entities.

9. The system of claim 8, wherein one or more of the processors are further configured to:
compute one or more predictive probability scores by the trained second machine learning model, wherein one or more of the computed predictive probability scores comprise a probability for a true match between the one or more of the extracted text components and one or more of the corresponding reference components, indicating whether the text input and the reference component refer to a single, real-world entity; and
perform one or more automated actions, the automated actions comprising: blocking an exchange of data, delaying an exchange of data, and permitting an exchange of data, wherein the one or more automated actions are performed based on the one or more of the computed predictive probability scores.

10. The system of claim 9, wherein the probability for the true match distinguishes true entity matches from false positive matches, wherein the false positive matches arise when two names refer to different real-world entities despite appearing similar.

11. The system of claim 9, wherein the one or more automated actions are performed based on one or more alerts, the one or more alerts generated based on one or more of the computed predictive probability scores, wherein the alerts are categorized into a plurality of risk levels, and wherein each risk level corresponds to a risk threshold applied to the predictive probability scores, the risk thresholds defining an escalation queue for a first risk level, a standard queue for a second risk level, and a hibernation queue for a third risk level.

12. The system of claim 8, wherein the one or more similarity scores are calculated using one or more vector embeddings for the one or more of the extracted text components, the one or more vector embeddings computed using a third machine learning model that is an embedding model separate and distinct from both the first machine learning model and the second machine learning model, wherein the vector embeddings encode semantic representations of the extracted text components.

13. The system of claim 8, wherein the text input describes an exchange of data over a computer network, the exchange of data involving the entity, wherein the one or more of the extracted text components comprises one or more of: a qualification, a country's name, a name, and a gender, and wherein the watchlist of entities is maintained for regulatory compliance screening, the watchlist of entities comprising at least one of a sanctions list, a politically exposed persons (PEP) list, or an adverse media list.

14. The system of claim 8, wherein one or more of the processors are further configured to train the second machine learning model using one or more of: a count value for the extracted text components, and a number of the similarity scores below a predetermined threshold, wherein the second machine learning model is a gradient boosting model and a labeled training dataset for training the second machine learning model comprises historical entity matching records labeled as true matches or false positives.

15. A computerized method of machine learning based entity resolution, comprising, using one or more computer processors:
identifying, by a first machine learning model comprising a large language model (LLM), one or more text segments from a text input, the text input identifying an entity; and
training a second machine learning model, separate and distinct from the first machine learning model, using one or more similarity features, the one or more similarity features computed for: one or more of the identified text segments, and one or more reference segments from a watchlist of entities.

16. The method of claim 15, further comprising:
outputting one or more probabilities by the trained second machine learning model, wherein one or more of the outputted probabilities comprise a probability for a true match between the one or more of the identified text segments and one or more of the reference segments, indicating whether the text input and the reference segment refer to a single, real-world entity; and
executing one or more automated actions, the automated actions comprising: declining an exchange of data, delaying an exchange of data, and allowing an exchange of data, wherein the one or more automated actions are executed based on the one or more of the outputted probabilities.

17. The method of claim 16, wherein the probability for the true match distinguishes true entity matches from false positive matches, wherein the false positive matches arise when two names refer to different real-world entities despite appearing similar.

18. The method of claim 16, wherein the one or more automated actions are executed based on one or more alerts, the one or more alerts generated based on one or more of the outputted probabilities, wherein the alerts are grouped into a plurality of risk levels, and wherein each risk level corresponds to a risk threshold applied to the outputted probabilities, the risk thresholds defining an escalation queue for a first risk level, a standard queue for a second risk level, and a hibernation queue for a third risk level.

19. The method of claim 15, wherein the one or more similarity features are computed using one or more numerical embeddings for the one or more of the identified text segments, the one or more numerical embeddings generated using a third machine learning model that is an embedding model separate and distinct from both the first machine learning model and the second machine learning model, wherein the numerical embeddings encode semantic representations of the identified text segments.

20. The method of claim 15, wherein the text input describes an exchange of data over a computer network, the exchange of data involving the entity, wherein the one or more of the identified text segments comprises one or more of: a qualification, a country's name, a given name, and a gender, and wherein the watchlist of entities is maintained for regulatory compliance screening, the watchlist of entities comprising at least one of a sanctions list, a politically exposed persons (PEP) list, or an adverse media list.
